(19) United States
(12) Patent Application Publication
(10) Pub. No.: US 2005/0039379 A1
(43) Pub. Date: Feb. 24, 2005

(54) Method and apparatus for controlling pests found in the ground, in particular termites

(76) Inventor: Hartwig Pollinger, Aosta (IT)

Correspondence Address: NILS H. LJUNGMAN;NILS H. LJUNGMAN & ASSOCIATES, P.O. BOX 130, GREENSBURG, PA, 15601, US

(21) Appl. No.: 10/951,245

(22) Filed: Sep. 27, 2004

Related U.S. Application Data
(63) Continuation-in-part of application No. PCT/EP03/03186, filed on Mar. 27, 2003.

(30) Foreign Application Priority Data
Mar. 28, 2002 (DE) 102 13 983.0

(51) Int. Cl. A01M 1/20; A01M 17/00

(52) U.S. Cl. 43/132.1

(57) ABSTRACT

A method and apparatus for controlling pests found in the ground, in particular termites. The object is achieved firstly by determining nests located in the ground using a localization method indicating underground cavities and then by drilling a hole from the earth's surface to the localized cavity. An antenna connected to a microwave generator is then inserted in the drilled hole until it is approximately in the localized cavity, and then microwave energy is radiated via the antenna into the ground in the region around the localized cavity. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP03/03186, filed on Mar. 27, 2003, which claims priority from Federal Republic of Germany Patent Application No. 102 13 983.0, filed on Mar. 28, 2002. International Patent Application No. PCT/EP03/03186 was pending as of the filing date of this application. The United States was an elected state in International Patent Application PCT/EP03/03186.

### BACKGROUND

1. Technical Field

The present application relates to a method and an apparatus for controlling animal pests found in the ground, in particular termites.

2. Background Information

Animal pests are understood to mean, as is known, animals which in a broader sense cause damage to people or their economy. Predominantly, but not exclusively, they are insects. An important group of animal pests are wood pests, such as termites, which feed on wood (cellulose) and which can cause considerable damage both to living undergrowth and building timber.

Termites are tropical insects which live in colonies of many millions of individual animals in tree trunks, cavities or even structures made from loam and feces. A termite colony living underground may extend to the dimensions of a soccer pitch. In particular in (subtropical) wine-growing regions, they cause considerable damage to the vines and thus to profits since they can spread more or less unimpeded.

It is predominantly known for protecting structures to control termites and other pests using chemical means, in particular toxic substances (cf. WO 01/26456 A1, EP 0 587 116 A1, WO 97/26788 A1). These methods are certainly largely effective. However, owing to the unfavorable environmental influences and the risk of the toxic substances entering the human food chain and thus the associated potential risks to health, the chemical/toxic control of termites and similar animal pests in wine-growing regions is extremely problematic.

DE 38 04 052 A1 furthermore discloses animal and/or plant organisms, such as garden pests, microorganisms or weeds, to be killed by being exposed to microwaves. The corresponding apparatus has a microwave transmitter known per se which has, on the side facing the organisms, a radiation opening for microwaves. In one variant, the microwave transmitter is fitted close to the ground, has rollers and a handle such that the apparatus allows punctiform or linear irradiation of ground areas when it is moved.

Using this known apparatus, above-ground control of the corresponding organisms is possible in an extremely effective manner whilst avoiding chemical/toxic active ingredients and their consequences, the pests, owing to their relatively high water content, being reliably killed off by being heated beyond the lethal temperature for an appropriate exposure time. However, the microwaves emitted only penetrate the ground to a negligible extent. Accordingly, it is not possible to effectively control pests found at depths of, for example, 1.5 m to 2 m.

The nests of termites living in the ground are at such depths. They generally accommodate, as the only reproductive animal in a colony, a queen which lays an egg every three seconds whilst the nonreproductive worker and soldier animals provide nutrition for the queen and her eggs and provide defense using tunnel networks branching out in all directions.

### OBJECT OR OBJECTS

In view of the known prior art, the invention is based on the object of specifying a method and an apparatus for controlling animal pests found in the ground, in particular termites, in which microwave energy is used with relatively little complexity whilst avoiding harmful health-related consequences for humans to reliably destroy at least the reproductive animal pests and, if possible, their eggs too.

### SUMMARY

This object is achieved according to the invention with a method having the following steps:
a. determining nests located in the ground using a localization method indicating underground cavities,
b. drilling a hole from the earth's surface to the localized cavity,
c. inserting an antenna connected to a microwave generator in the drilled hole until it is approximately in the localized cavity,
d. radiating microwave energy via the antenna into the ground in the region around the localized cavity.

The object is achieved according to the invention firstly by determining nests located in the ground using a localization method indicating underground cavities and then by drilling a hole from the earth's surface to the localized cavity. An antenna connected to a microwave generator is then inserted in the drilled hole until it is approximately in the localized cavity, and then microwave energy is radiated via the antenna into the ground in the region around the localized cavity.

In addition, the object is achieved according to the invention with an apparatus, in which a microwave generator is connected via a coaxial cable to a hollow-conductor antenna which can be inserted in a drilled hole in the ground and has, at the lower end, an adapter element for providing optimum energy transfer into the ground.

The method according to the invention and the apparatus designed according to the invention make possible an extremely effective way of controlling animal pests found in the ground. In particular, the self-propagating termites living at greater depths may be destroyed in an effective and environmentally friendly manner by using electromagnetic fields in the microwave range in a targeted and pin-pointed manner. Consequential damage for humans, animals and nature is in principle ruled out when using the device in the appropriate manner. By localizing the underground nests and introducing and radiating the microwave energy into the nests in a targeted manner, the control of the termites of a colony which have considerably spread themselves out in the area of land can be concentrated on the points which are critical for successful control.

In this case it is particularly advantageous to localize the nests containing the reproductive animals of the pests, in particular the egg-laying queen, and to irradiate them with microwave energy. It is thus possible to effectively prevent both the laying of new eggs and the continued growth of future generations. This is based on the knowledge that the destruction of individual animals, even in relatively large numbers, brings with it only a negligible amount of success owing to the millions of animals within a colony, unless the reproductive animals are removed. Only by this means can the continued growth of future generations be controlled.

The apparatus according to one embodiment provides optimum introduction and radiation of microwave energy directly into the underground nest or into the surrounding ground, the depth of the nest having no negative influence on the field strength and thus the effect of the electromagnetic field.

In one advantageous refinement of the method according to an embodiment of the invention, the localization method functions by energy pulses being emitted and their reflections being evaluated. In this case, it is particularly expedient for sound, ultrasound or electromagnetic wave pulses to be used as the energy pulses. The use of a ground radar device has proved to be particularly favorable and effective.

In a further expedient refinement of the method, the hole is drilled approximately at right angles to the earth's surface and has an inner diameter which is greater than the outer diameter of the antenna to be inserted. In one particularly cost-effective realization, the hole may be drilled using a manual drilling device. However, it is also possible to use suitable mechanical drilling devices.

In one further advantageous embodiment, a hollow-conductor antenna may be used as the antenna. In this case, the hollow-conductor antenna expediently has an adapter element arranged at the lower end for optimum energy transfer into the ground. This adapter element is optimized for a defined range of ground humidity.

In one advantageous refinement, the method may also find application in biologically contaminated areas.

In one particularly advantageous refinement of the apparatus according to an embodiment of the invention, the hollow-conductor antenna comprises a metal tube or a metal alloy tube, whose upper end is sealed by means of a short-circuit plate, and whose lower end has a tapered section in which the adapter element is fixed. As a result, the microwave energy can be introduced into the localized nest in a favorable manner. In this case, the tube of the hollow-conductor antenna is expediently made of copper or a copper alloy. The adapter element is in the form of a dielectric insert, and is expediently made of Teflon or a similar dielectric plastic material. In one advantageous variant, the adapter element has the form of a cylindrical basic body which widens at both ends in the form of a cone. In one further advantageous variant, the adapter element has the form of a cylindrical basic body which is recessed one or more times in the form of a cylinder in the direction of the interior of the tube of the hollow-conductor antenna. As a result, optimum energy transfer into the ground in the region of the nest is ensured. The propagation of the electromagnetic field takes place, depending on the composition of the ground (for example stones) and humidity, in the manner of a sphere around the end of the hollow-conductor antenna and with a corresponding penetration depth. This ensures that the microwave energy reaches the nest in any case even if the hole is not drilled accurately.

Since the queen is severely degenerate, i.e. is now specifically only for egg laying, it cannot escape and remove itself from the electromagnetic field. The exposure time to the microwave energy is thus in any case sufficiently long to achieve an increase in the body temperature which is sufficient to kill it off.

In a further expedient embodiment of the apparatus, the upper end of the hollow-conductor antenna is provided with a connection point for the coaxial cable, whose threaded part is connected to the tube of the hollow-conductor antenna, and whose contact pin is connected to a coupling pin which projects into the interior of the hollow-conductor antenna transversely to its longitudinal axis. The action of the coupling pin, together with the short-circuit plate located at the upper end of the hollow-conductor antenna, causes the microwaves to propagate in the air column of the hollow-conductor antenna in the direction of its lower end having the adapter element such that optimum microwave transfer and optimum microwave entry into the ground or nest is ensured.

The microwave generator advantageously contains a magnetron, whose microwave power and/or operating frequency is constant or can be adjusted.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The invention will be explained in more detail below using an exemplary embodiment. In the associated drawing:

FIG. 1 shows an apparatus in use for controlling underground termites,

FIG. 2 shows the axial section through a hollow-conductor antenna in a first design variant, and

FIG. 3 shows the interrupted axial section through a hollow-conductor antenna in a second design variant.

### DESCRIPTION OF EMBODIMENT OR EMBODIMENTS

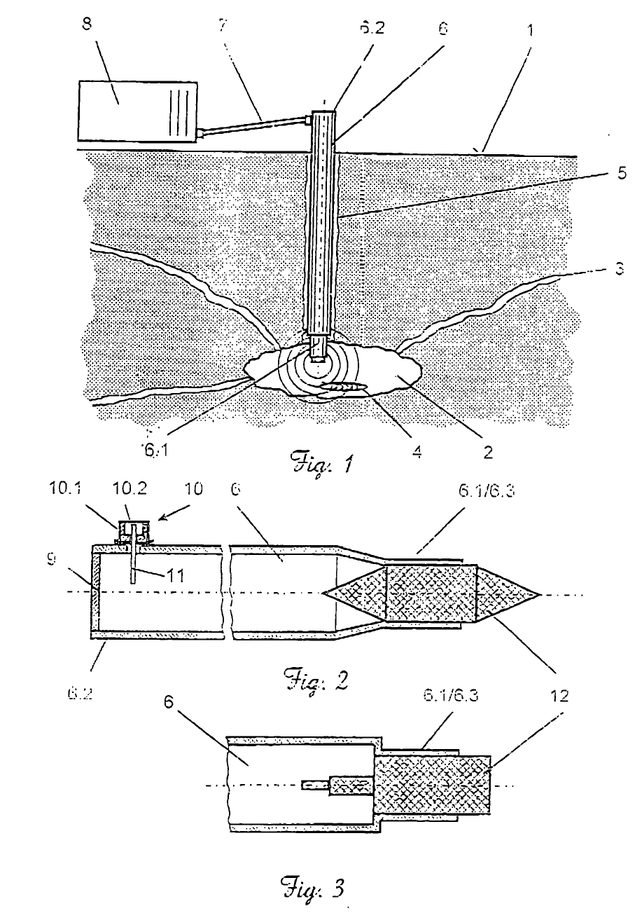

At a depth of approximately 1.5-2 m in the ground 1 of a wine-growing region (cf. FIG. 1) are found nests 2 of a colony of termites. These nests are connected to one another and/or to the surface by tunnels 3 through which the termites pass.

In one nest 2 there lives a queen 4 which lays eggs practically uninterrupted as it is the only reproductive animal in a colony. She and the eggs are supplied with nourishment by working animals (using the tunnels 3), whilst soldier animals provide the defense.

When carrying out the method according to the invention, initially a commercial ground radar device (not shown) which is hand-operated in the example is moved, for example in the form of strips, over the surface of the ground 1 of the wine-growing area. In this case, the radar device emits electromagnetic energy pulses. The reflected electromagnetic echo is influenced by the different structures and materials of the ground 1 having different dielectric and reflection properties. Correspondingly, the radargram obtained contains corresponding information which, on analysis, provides a detection result. As long as there are nests 2 in the ground 1, they can be localized in this manner with high accuracy. The monitor of the ground radar device gives both the position and the depth of the nests 2.

According to the second method step, an approximately perpendicular drilled hole 5 is drilled from the surface of the ground 1 to the depth of the localized nest 2. For this purpose, a known manual drilling device (not shown) is used in a simple manner, but a suitable mechanical drilling device may also be used. The diameter of the drilled hole 5 is approximately 100 mm.

According to the third method step, a hollow-conductor antenna 6 is inserted in the drilled hole 5 and is pushed with its lower end 6.1 approximately into the nest 2. The hollow-conductor antenna 6 is connected via a coaxial cable 7 to a microwave generator 8. When it is put into operation, microwave energy is transferred via the coaxial cable 7 to the hollow-conductor antenna 6 and is emitted at the lower end 6.1 of said hollow-conductor antenna 6 in the manner of a sphere in the region of the nest 2. The exposure time to said microwave energy is, corresponding to the effective field strength, sufficiently long to achieve such an increase in the body temperature of the queen 4 (and other animals present in the nest 2 and the eggs) which leads to their death.

The microwave generator 8 contains a magnetron (not shown) which produces a power of approximately 1 kW at an operating frequency of 2.45 GHz. It is optionally possible to adjust the microwave generator 8 as regards the power and/or operating frequency.

The hollow-conductor antenna 6 developed especially for application in the method according to the invention (cf. FIGS. 2 and 3) is made in terms of its geometrical basic shape from a cylindrical copper tube, whose upper end 6.2 is sealed by a short-circuit plate 9. In the region of the upper end 6.2, a connection point 10 for the coaxial cable 7 is additionally provided, whose outer threaded part 10.1 for receiving a screwed cap of the coaxial cable 7 (FIG. 2) is electrically connected to the tube of the hollow-conductor antenna 6. The contact pin 10.2 is, on the other hand, insulated with respect to the tube, connected to a coupling pin 11 projecting transversely into the tube interior. This construction ensures that the microwaves are propagated in the air column of the tube of the hollow-conductor antenna 6 in the direction of its lower end 6.1.

The lower end 6.1 of the tube of the hollow-conductor antenna 6 is provided with a tapered section 6.3 in which an adapter element 12 is fixed. This adapter element 12 serves the purpose of providing optimum microwave energy transfer into the ground 1, the energy transfer being matched to the ground composition and humidity by means of the design and dimensioning of the adapter element 12.

The adapter element 12 is in the form of a dielectric insert and, in the exemplary embodiment, is made of Teflon with a very high grade of purity. However, it is also possible to use other (if possible wear-resistant) plastic materials having similar dielectric properties with a corresponding design/dimensions.

In a first design variant (FIG. 2), the adapter element 12 has a cylindrical basic body which widens at both ends in the form of a cone. In this case, the cone located in the tube interior ensures effective injection of the microwave energy.

In the second design variant (FIG. 3) which is simpler to produce, the adapter element 12 also has a cylindrical basic body which is however recessed twice in a cylindrical manner in the direction of the interior of the tube of the hollow-conductor antenna 6. The adapter element 12 shown in FIG. 3 is closed off on the outside such that it is flat.

The invention is not restricted by the details of the exemplary embodiment described above. In particular, the method may be realized using a suitable localization method which functions using other energy, such as sound waves, ultrasound waves or other waves.

One feature or aspect of an embodiment is believed at the time of the filing of this patent application to possibly reside broadly in a method for controlling pests found in the ground, in particular termites, using an antenna, which is connected to a microwave generator and which can be inserted in a pest's nest, microwave energy being radiated via the antenna, characterized in that nests containing the reproductive pests, in particular the egg-laying queen, are localized, reached from the earth's surface through a drilled hole and are irradiated with microwave energy by means of an antenna (6) inserted via the drilled hole.

Another feature or aspect of an embodiment is believed at the time of the filing of this patent application to possibly reside broadly in the method for controlling pests found in the ground, characterized in that the nests are localized using a localization method by energy pulses being emitted and their reflections being evaluated.

Yet another feature or aspect of an embodiment is believed at the time of the filing of this patent application to possibly reside broadly in the method for controlling pests found in the ground, characterized in that sound, ultrasound or electromagnetic wave pulses are used as the energy pulses.

Still another feature or aspect of an embodiment is believed at the time of the filing of this patent application to possibly reside broadly in the method for controlling pests found in the ground, characterized by the use of a ground radar device.

A further feature or aspect of an embodiment is believed at the time of the filing of this patent application to possibly reside broadly in the method for controlling pests found in the ground, characterized in that the hole is drilled approximately at right angles to the earth's surface and has an inner diameter which is greater than the outer diameter of the antenna to be inserted.

A further feature or aspect of an embodiment is believed at the time of the filing of this patent application to possibly reside broadly in the method for controlling pests found in the ground, characterized in that the hole is drilled using a manual drilling device.

Another feature or aspect of an embodiment is believed at the time of the filing of this patent application to possibly reside broadly in the method for controlling pests found in the ground, characterized in that a hollow-conductor antenna is used as the antenna.

A further feature or aspect of an embodiment is believed at the time of the filing of this patent application to possibly reside broadly in the method for controlling pests found in the ground, characterized in that the hollow-conductor antenna has an adapter element arranged at the lower end for optimum energy transfer into the ground.

Another feature or aspect of an embodiment is believed at the time of the filing of this patent application to possibly reside broadly in the method for controlling pests found in the ground, characterized in that the adapter element is optimized for a defined range of ground composition and humidity.

Yet another feature or aspect of an embodiment is believed at the time of the filing of this patent application to possibly reside broadly in the method for controlling pests found in the ground, characterized by its application in biologically contaminated areas.

Still another feature or aspect of an embodiment is believed at the time of the filing of this patent application to possibly reside broadly in an apparatus for controlling animal pests found in the ground, in particular termites, by means of an antenna, which is connected via a coaxial cable to a microwave generator, and which can be inserted in a pest's nest, microwave energy being radiated via the antenna, characterized in that the antenna is in the form of a hollow-conductor antenna which can be inserted in the ground and comprises a metal tube or a metal alloy tube, whose upper end is sealed by a short-circuit plate, and whose lower end has a tapered section in which an adapter element, which is in the form of a dielectric insert, is fixed.

A further feature or aspect of an embodiment is believed at the time of the filing of this patent application to possibly reside broadly in the apparatus for controlling pests found in the ground, characterized in that the tube of the hollow-conductor antenna is made of copper or a copper alloy.

Another feature or aspect of an embodiment is believed at the time of the filing of this patent application to possibly reside broadly in the apparatus for controlling pests found in the ground, characterized in that the adapter element is made of Teflon or a similar dielectric plastic material.

Yet another feature or aspect of an embodiment is believed at the time of the filing of this patent application to possibly reside broadly in the apparatus for controlling pests found in the ground, characterized in that the adapter element has the form of a cylindrical basic body which widens at both ends in the form of a cone.

Still another feature or aspect of an embodiment is believed at the time of the filing of this patent application to possibly reside broadly in the apparatus for controlling pests found in the ground, characterized in that the adapter element has the form of a cylindrical basic body which is recessed one or more times in the form of a cylinder in the direction of the interior of the tube of the hollow-conductor antenna.

Another feature or aspect of an embodiment is believed at the time of the filing of this patent application to possibly reside broadly in the apparatus for controlling pests found in the ground, characterized in that the upper end (6.2) of the hollow-conductor antenna (6) is provided with a connection point (10) for the coaxial cable (7), whose threaded part (10.1) is connected to the tube of the hollow-conductor antenna (6), and whose contact pin (10.2) is connected to a coupling pin (11) which projects into the interior of the hollow-conductor antenna (6) transversely to its longitudinal axis.

A further feature or aspect of an embodiment is believed at the time of the filing of this patent application to possibly reside broadly in the apparatus for controlling pests found in the ground, characterized in that the microwave generator (8) contains a magnetron, whose microwave power and/or operating frequency is constant or can be adjusted.

A further feature or aspect of an embodiment is believed at the time of the filing of this patent application to possibly reside broadly in a method for controlling pests found in the ground, in particular termites, said method comprising the steps of: using a ground penetrating radar device to locate nests containing the reproductive pests, in particular the egg-laying queen; forming a hole from the earth's surface to permit an antenna to be inserted into said hole at least in the proximity of said nest; inserting a microwave antenna into the hole at least in the proximity of a pest's nest, which pest's nest has been located using said ground penetrating radar device, said microwave antenna being connected to a microwave generator; and radiating microwave energy via the antenna into the hole at least in the proximity of a pest's nest.

Another feature or aspect of an embodiment is believed at the time of the filing of this patent application to possibly reside broadly in the method for controlling pests found in the ground, characterized in that the hole is drilled approximately at right angles to the earth's surface and has an inner diameter which is greater than the outer diameter of the antenna to be inserted; and characterized in that the hole is drilled using a manual drilling device.

Yet another feature or aspect of an embodiment is believed at the time of the filing of this patent application to possibly reside broadly in the method for controlling pests found in the ground, characterized in that: a hollow-conductor antenna is used as the antenna; the hollow-conductor antenna has an adapter element arranged at the lower end for optimum energy transfer into the ground; the adapter element is optimized for a defined range of ground composition and humidity; and characterized by its application in biologically contaminated areas.

Still another feature or aspect of an embodiment is believed at the time of the filing of this patent application to possibly reside broadly in a method for controlling pests found in the ground, in particular termites, characterized by the following steps: determining nests located in the ground using a localization method indicating underground cavities; drilling a hole from the earth's surface to the localized cavity; inserting an antenna connected to a microwave generator in the drilled hole until it is approximately in the localized cavity; radiating microwave energy via the antenna into the ground in the region around the localized cavity.

Yet another feature or aspect of an embodiment is believed at the time of the filing of this patent application to possibly reside broadly in the method for controlling pests found in the ground, characterized in that the nests containing the reproductive animals of the pests, in particular the egg-laying queen, are localized and irradiated with microwave energy.

Another feature or aspect of an embodiment is believed at the time of the filing of this patent application to possibly reside broadly in the method for controlling pests found in the ground, characterized in that the localization method functions by energy pulses being emitted and their reflections being evaluated.

A further feature or aspect of an embodiment is believed at the time of the filing of this patent application to possibly reside broadly in the method for controlling pests found in the ground, characterized in that sound, ultrasound or electromagnetic wave pulses are used as the energy pulses.

Still another feature or aspect of an embodiment is believed at the time of the filing of this patent application to possibly reside broadly in the method for controlling pests found in the ground, characterized by the use of a ground radar device.

Yet another feature or aspect of an embodiment is believed at the time of the filing of this patent application to possibly reside broadly in the method for controlling pests found in the ground, characterized in that the hole is drilled approximately at right angles to the earth's surface and has an inner diameter which is greater than the outer diameter of the antenna to be inserted.

A further feature or aspect of an embodiment is believed at the time of the filing of this patent application to possibly reside broadly in the method for controlling pests found in the ground, characterized in that the hole is drilled using a manual drilling device.

Another feature or aspect of an embodiment is believed at the time of the filing of this patent application to possibly reside broadly in the method for controlling pests found in the ground, characterized in that a hollow-conductor antenna is used as the antenna.

Still another feature or aspect of an embodiment is believed at the time of the filing of this patent application to possibly reside broadly in the method for controlling pests found in the ground, characterized in that the hollow-conductor antenna has an adapter element arranged at the lower end for optimum energy transfer into the ground.

Yet another feature or aspect of an embodiment is believed at the time of the filing of this patent application to possibly reside broadly in the method for controlling pests found in the ground, characterized in that the adapter element is optimized for a defined range of ground composition and humidity.

A further feature or aspect of an embodiment is believed at the time of the filing of this patent application to possibly reside broadly in the method for controlling pests found in the ground and one or more of the preceding claims, characterized by its application in biologically contaminated areas.

Another feature or aspect of an embodiment is believed at the time of the filing of this patent application to possibly reside broadly in an apparatus for controlling animal pests found in the ground, in particular termites, characterized in that a microwave generator is connected via a coaxial cable to a hollow-conductor antenna which can be inserted in a drilled hole in the ground and has, at the lower end, an adapter element for providing optimum energy transfer into the ground.

Still another feature or aspect of an embodiment is believed at the time of the filing of this patent application to possibly reside broadly in the apparatus for controlling pests found in the ground, characterized in that the hollow-conductor antenna comprises a metal tube or a metal alloy tube, whose upper end is sealed by a short-circuit plate, and whose lower end has a tapered section in which the adapter element is fixed.

Yet another feature or aspect of an embodiment is believed at the time of the filing of this patent application to possibly reside broadly in the apparatus for controlling pests found in the ground, characterized in that the tube of the hollow-conductor antenna is made of copper or a copper alloy.

A further feature or aspect of an embodiment is believed at the time of the filing of this patent application to possibly reside broadly in the apparatus for controlling pests found in the ground, characterized in that the adapter element is in the form of a dielectric insert.

Another feature or aspect of an embodiment is believed at the time of the filing of this patent application to possibly reside broadly in the apparatus for controlling pests found in the ground, characterized in that the adapter element is made of Teflon or a similar dielectric plastic material.

Still another feature or aspect of an embodiment is believed at the time of the filing of this patent application to possibly reside broadly in the apparatus for controlling pests found in the ground, characterized in that the adapter element has the form of a cylindrical basic body which widens at both ends in the form of a cone.

Yet another feature or aspect of an embodiment is believed at the time of the filing of this patent application to possibly reside broadly in the apparatus for controlling pests found in the ground, characterized in that the adapter element has the form of a cylindrical basic body which is recessed one or more times in the form of a cylinder in the direction of the interior of the tube of the hollow-conductor antenna.

A further feature or aspect of an embodiment is believed at the time of the filing of this patent application to possibly reside broadly in the apparatus for controlling pests found in the ground, characterized in that the upper end of the hollow-conductor antenna is provided with a connection point for the coaxial cable, whose threaded part is connected to the tube of the hollow-conductor antenna, and whose contact pin is connected to a coupling pin which projects into the interior of the hollow-conductor antenna transversely to its longitudinal axis.

Still another feature or aspect of an embodiment is believed at the time of the filing of this patent application to possibly reside broadly in the apparatus for controlling pests found in the ground, characterized in that the microwave generator contains a magnetron, whose microwave power and/or operating frequency is constant or can be adjusted.

An example of a hand held radar that may possibly be utilized or adapted for use in at least one possible embodiment may possibly be found in U.S. Pat. No. 6,617,996, entitled “Ground penetrating radar with audible output.” Some further examples of ground penetrating radars which may possibly be utilized or adapted for use in at least one possible embodiment may possibly be found in the following U.S. Pat. No. 6,445,334, entitled “Ground penetrating radar system;” U.S. Pat. No. 6,522,285, entitled “Ground-penetrating imaging and detecting radar;” U.S. Pat. No. 6,603,422, entitled “Ground penetrating radar incorporating a real-time multi-target direction finding capability;” U.S. Pat. No. 6,664,914, entitled “Ground penetrating radar;” U.S. Pat. No. 6,700,526, entitled “Method and apparatus for identifying buried objects using ground penetrating radar;” and U.S. Pat. No. 6,741,201, entitled “Ground penetrating radar system and method for detecting an object on or below a ground surface.”

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Mar. 27, 2003, and/or cited elsewhere are hereby incorporated by reference as if set forth in their entirety herein as follows: U.S. Pat. No. 4,370,534, issued to Deryck on Jan. 25, 1983; U.S. Pat. No. 4,778,970, issued to Klaila on Oct. 18, 1988; U.S. Pat. No. 6,114,676, issued to Dikhtiar et al. on Sep. 5, 2000; U.S. Pat. No. 5,767,679, issued to Schroeder on Jun. 16, 1998; and BE 1 011 532, issued to Neefs on Oct. 5, 1999.

The corresponding foreign and international patent publication applications, namely, Federal Republic of Germany Patent Application No. 102 13 983.0, filed on Mar. 28, 2002, having inventor Hartwig POLLINGER, and DE-OS 102 13 983.0 and DE-PS 102 13 983.0, and International Application No. PCT/EP03/03186, filed on Mar. 27, 2003, having inventor Hartwig POLLINGER, as well as their published equivalents, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.
   List of Reference Numerals
1 Ground
2 Nest
3 Tunnel
4 Queen
5 Drilled hole
6 Hollow-conductor antenna
6.1 Lower end
6.2 Upper end
6.3 Tapered section
7 Coaxial cable
8 Microwave generator
9 Short-circuit plate
10 Connection point
10.1 Outer threaded part
10.2 Contact pin
11 Coupling pin
12 Adapter element

1. A method for controlling pests found in the ground, in particular termites, using an antenna, which is connected to a microwave generator and which can be inserted in a pest's nest, microwave energy being radiated via the antenna, characterized in that nests (2) containing the reproductive pests, in particular the egg-laying queen (4), are localized, reached from the earth's surface through a drilled hole (5) and are irradiated with microwave energy by means of an antenna (6) inserted via the drilled hole (5).

2. The method as claimed in claim 1, characterized in that the nests (2) are localized using a localization method by energy pulses being emitted and their reflections being evaluated.

3. The method as claimed in claim 2, characterized in that sound, ultrasound or electromagnetic wave pulses are used as the energy pulses.

4. The method as claimed in claim 3, characterized by the use of a ground radar device.

5. The method as claimed in claim 1, characterized in that the hole (5) is drilled approximately at right angles to the earth's surface and has an inner diameter which is greater than the outer diameter of the antenna (6) to be inserted.

6. The method as claimed in claim 5, characterized in that the hole (5) is drilled using a manual drilling device.

7. The method as claimed in claim 1, characterized in that a hollow-conductor antenna (6) is used as the antenna (6).

8. The method as claimed in claim 7, characterized in that the hollow-conductor antenna (6) has an adapter element (12) arranged at the lower end (6.1) for optimum energy transfer into the ground. (1).

9. The method as claimed in claim 8, characterized in that the adapter element (12) is optimized for a defined range of ground composition and humidity.

10. The method as claimed in claim 1, characterized by its application in biologically contaminated areas.

11. An apparatus for controlling animal pests found in the ground, in particular termites, by means of an antenna, which is connected via a coaxial cable to a microwave generator, and which can be inserted in a pest's nest, microwave energy being radiated via the antenna, characterized in that the antenna (6) is in the form of a hollow-conductor antenna (6) which can be inserted in the ground (1) and comprises a metal tube or a metal alloy tube, whose upper end (6.2) is sealed by a short-circuit plate (9), and whose lower end (6.1) has a tapered section (6.3) in which an adapter element (12), which is in the form of a dielectric insert, is fixed.

12. The apparatus as claimed in claim 11, characterized in that the tube of the hollow-conductor antenna (6) is made of copper or a copper alloy.

13. The apparatus as claimed in claim 11, characterized in that the adapter element (12) is made of Teflon or a similar dielectric plastic material.

14. The apparatus as claimed in claim 13, characterized in that the adapter element (12) has the form of a cylindrical basic body which widens at both ends in the form of a cone.

15. The apparatus as claimed in claim 13, characterized in that the adapter element (12) has the form of a cylindrical basic body which is recessed one or more times in the form of a cylinder in the direction of the interior of the tube of the hollow-conductor antenna (6).

16. The apparatus as claimed in claim 15, characterized in that the upper end (6.2) of the hollow-conductor antenna (6) is provided with a connection point (10) for the coaxial cable (7), whose threaded part (10.1) is connected to the tube of the hollow-conductor antenna (6), and whose contact pin (10.2) is connected to a coupling pin (11) which projects into the interior of the hollow-conductor antenna (6) transversely to its longitudinal axis.

17. The apparatus as claimed in claim 16, characterized in that the microwave generator (8) contains a magnetron, whose microwave power and/or operating frequency is constant or can be adjusted.

18. A method for controlling pests found in the ground, in particular termites, said method comprising the steps of:
using a ground penetrating radar device to locate nests containing the reproductive pests, in particular the egg-laying queen;
forming a hole from the earth's surface to permit an antenna to be inserted into said hole at least in the proximity of said nest;
inserting a microwave antenna into the hole at least in the proximity of a pest's nest, which pest's nest has been located using said ground penetrating radar device, said microwave antenna being connected to a microwave generator; and
radiating microwave energy via the antenna into the hole at least in the proximity of a pest's nest.

19. The method as claimed in claim 18, characterized in that the hole is drilled approximately at right angles to the earth's surface and has an inner diameter which is greater than the outer diameter of the antenna to be inserted; and
characterized in that the hole is drilled using a manual drilling device.

20. The method as claimed in claim 20, characterized in that:
a hollow-conductor antenna is used as the antenna;
the hollow-conductor antenna has an adapter element arranged at the lower end for optimum energy transfer into the ground;
the adapter element is optimized for a defined range of ground composition and humidity; and
characterized by its application in biologically contaminated areas.
